(19) United States
(12) Patent Application Publication
(10) Pub. No.: US 2017/0168228 A1
(43) Pub. Date: Jun. 15, 2017

(54) BACKLIGHT MODULE AND DISPLAY DEVICE

(71) Applicant: Shenzhen China Star Optoelectronics Technology Co. Ltd., Shenzhen, Guangdong (CN)

(72) Inventors: Gang YU, Guangdong (CN); Dehua LI, Guangdong (CN)

(21) Appl. No.: 14/888,647

(22) PCT Filed: Sep. 14, 2015
(86) PCT No.: PCT/CN2015/089532

§ 371 Date: Nov. 2, 2015

(30) Foreign Application Priority Data
Sep. 9, 2015 (CN) 201510570572.8

(51) Int. Cl. F21V 8/00

(52) U.S. Cl. CPC G02B 6/0088

(57) ABSTRACT

A backlight module including a light guide plate and an optical film assembly, which are stacked, and a plurality of limited blocks, wherein, engagement portions are disposed to protrude from a periphery of the light guide plate, the number of the engagement portions is same as that of the limited blocks, and the limited blocks are fixed to a back portion of the optical film assembly, and engaged within the engagement portions. A display device is also disclosed.

### BACKGROUND OF THE INVENTION

1. Field of the Invention

The present invention relates to a liquid crystal display technical field, and more particularly to a backlight module and a display device.

2. The Related Arts

As a liquid crystal display (LCD) device is widely used in various fields, people have higher demands for thinness and narrow bezel of the LCD device, and require a thickness of a LCD module as thin as possible and a bezel as narrow as possible. However, in order to fix various components in the LCD device, generally, it is necessary to reserve a space for designing a positioning structure in each component, which inevitably increases a thickness and a width of the entire LCD device. Thus, it is extremely significant to fix the display device without affecting its thickness and a width of its bezel.

### SUMMARY

Due to the disadvantages existing in the prior art, the present invention provides a backlight module and a display device capable of being reliably fixed while being helpful for achieving thinness and narrow bezel.

In order to achieve the above purpose, the present invention adopts a following technical solution:

a backlight module includes a light guide plate and an optical film assembly, which are stacked, and a plurality of limited blocks, wherein, engagement portions are disposed to protrude from a periphery of the light guide plate, the number of the engagement portions is the same as that of the limited blocks, and the limited blocks are fixed to a back portion of the optical film assembly, and engaged within the engagement portions.

The engagement portions may be disposed on at least two opposite side walls of the light guide plate in pairs.

A gap having a shape consistent with that of a corresponding one among the limited blocks may be provided in each of the engagement portions, and the limited block may be inserted into and caught in the gap.

The limited blocks may be in a rectangle shape.

The limited blocks may be in a trapezoid shape.

An Opening of the gap may become bigger as being farther away from a center of the light guide plate.

An opening of the gap may become smaller as being farther away from the center of the light guide plate.

A height of each limited block may be higher than that of each engagement portion.

Hangers protrude from the periphery of the optical film assembly, and the number of the hangers is the same as that of the limited blocks, and the limited blocks are adhesive to surfaces of the hangers.

Another object of the present invention is to provide a display device including a display panel and said backlight module, the display panel being disposed on the backlight module.

According to the present invention, the plurality of limited blocks and engagement portions matched with them are provided at the periphery of the backlight module, and the light guide plate and the optical film assembly are limited by the limited blocks, so that it is helpful for reducing the space occupied by the positioning structures of a reflective sheet, the light guide plate and the optical film assembly, and for designing a ultra-thin display device with the narrower bezel, thereby improving an assembling efficiency of the products.

### BRIEF DESCRIPTION OF THE DRAWINGS

FIG. 1 is a perspective view illustrating a structure of a display device according to an exemplary embodiment 1 of the present invention.

FIG. 2 is an enlarger view illustrating a local structure of a display device according to the exemplary embodiment 1 of the present invention.

FIG. 3 is an enlarger view of a perspective view illustrating a local structure of a display device according to the exemplary embodiment 1 of the present invention.

FIG. 4 is a local cross sectional view of a display device according to the exemplary embodiment 1 of the present invention.

FIG. 5 is a local enlarger view of a display device according to an exemplary embodiment 2 of the present invention.

FIG. 6 is an enlarger view of a perspective view of a display device according to an exemplary embodiment 3 of the present invention.

### DETAILED DESCRIPTION OF EXEMPLARY EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein.

### Embodiment 1

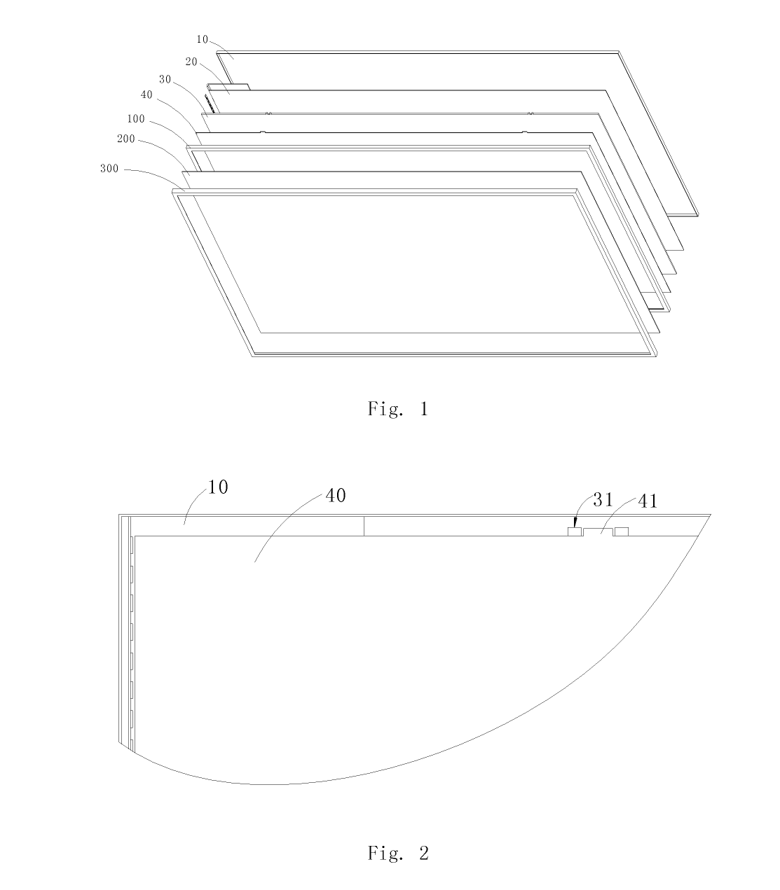

Referring to FIG. 1, a display device according to the present invention includes a rubber frame 100, a front frame 200, a display panel 300, a back plate 10, a reflective sheet 20, a light guide plate 30, and an optical film assembly 40, wherein the rubber frame 100, and the back plate 10, the reflective sheet 20, the light guide plate 30 and the optical film assembly 40 in the rubber frame 100 constitute a portion of a backlight module, the display panel 300 is attached to the rubber frame 100, and the front frame 200 covers an external surface of the display panel 300 to perform functions of protection and limitation.

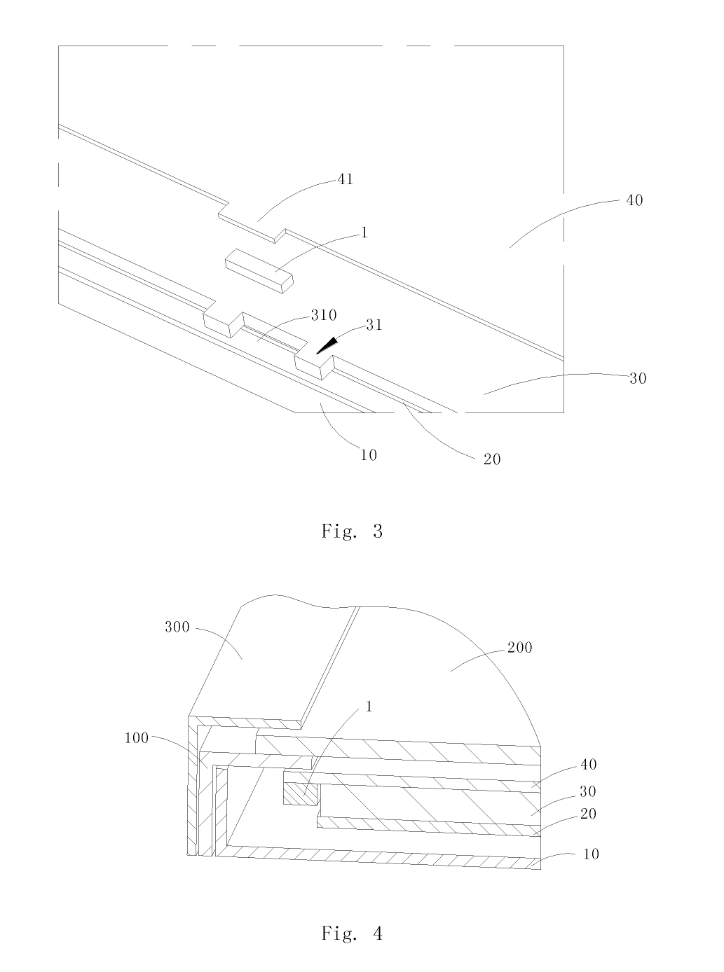

As illustrated in FIGS. 2-4, in the backlight module, the reflective sheet 20, the light guide plate 30 and the optical film assembly 40 are sequentially stacked on the back plate 10; a plurality of limited blocks 1 are fixed to a back surface of the optical film assembly 40; engagement portions 31 are disposed to protrude from a periphery of the light guide plate 30, the number of the engagement portions 31 is the same as that of the limited blocks 1, and each of the limited blocks 1 is engaged within a corresponding one among the engagement portions 31.

The engagement portions 31 protrude from two opposite side walls of the light guide plate 30 in pairs, symmetrically, in order to ensure the forces applied to the inner components of the backlight module consistent with each other. A gap 310 having a shape consistent with that of each of the limited block 1 is provided in each of the engagement portions 31, and the limited blocks 1 are inserted into and caught in the gaps 310. In the present embodiment, the limited blocks 1 are regular rectangle blocks.

Hangers 41 protrude from a periphery of the optical film assembly 40, the number of the hangers 41 is the same as that of the limited blocks 1, and the limited blocks 1 are attached to surfaces of the hangers 41. Furthermore, a height of each limited block 1 is higher than a thickness of each engagement portion 31 so that the limited block 1 may not be easily taken off from the engagement portion 31 after the limited block 1 is inserted into the engagement portion 31, thereby achieving a good fit between the optical film assembly 40 and the light guide plate 30.

During the specific assembling, it is first to adhere the limited blocks 1 to back surfaces of the hangers 41 of the optical film assembly 40, and then enable the hangers 41 of the optical film assembly 40 to correspond to positions of the engagement portions 31 on the light guide plate 30; the hangers 41 are pressed downward to enable the respective limited blocks 1 to be inserted into the corresponding gaps 310 for being caught; since the engagement portions 31 are provided in pairs, the optical film assembly 40 bears a certain stress after being assembled, which ensures a limitation and tensity of the optical film assembly 40 in a horizontal direction.

Since merely the hangers 41 and the engagement portions 31 for fixation are respectively disposed to protrude from the peripheries of the optical film assembly 40 and the light guide plate 30, the optical film assembly 40 and the light guide plate 30 may be designed very small, without remarkably increasing the width of the bezel of the display device and affecting the thickness of the display device at all, thereby being helpful for further thinning the display device with narrower bezel.

### Embodiment 2

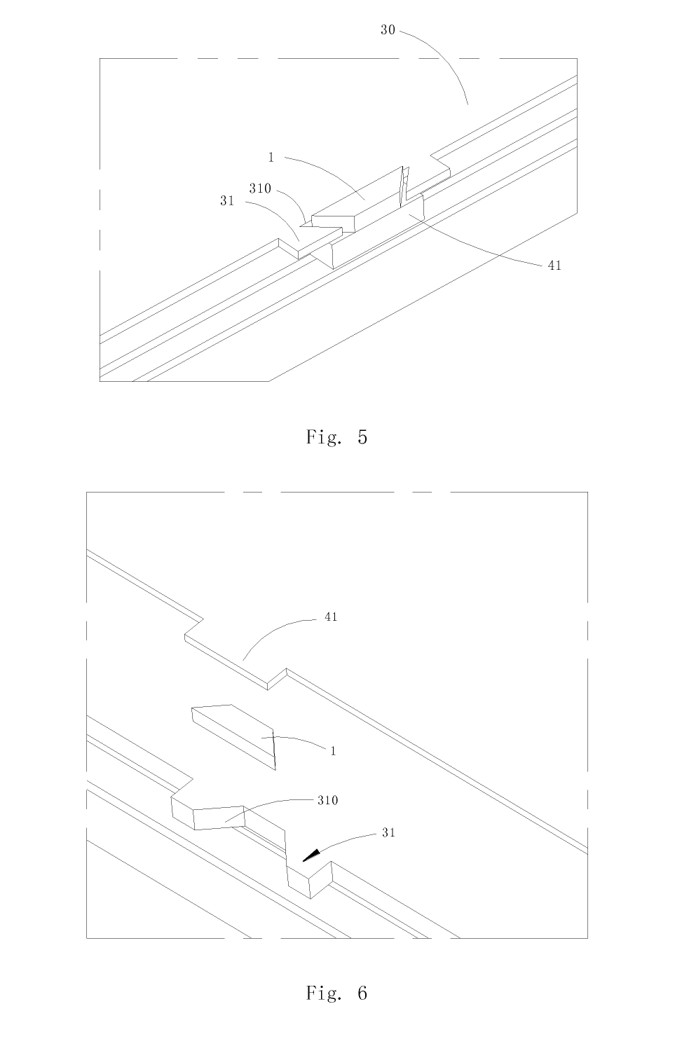

As illustrated in FIG. 5, it is different from the embodiment 1. The limited blocks 1 according to the present embodiment are in a trapezoid shape, and the gaps 310 of the light guide plate 30 are also in the trapezoid shape accordingly. Moreover, the openings of the gaps 310 become smaller as being farther away from a center of the light guiding plate 30. In comparison with the rectangle limited blocks 1 in the embodiment 1, the limited blocks 1 and the gaps 310 of the light guide plate 30 according to the present embodiment are engaged with each other in a higher level, so that the limited blocks 1 may not be easily taken off.

### Embodiment 3

As illustrated in FIG. 6, the limited blocks 1 according to the present embodiment are also in a trapezoid shape, but the openings of the gaps 310 of the light guide plate 30 become bigger as being farther away from the center of the light guide plate 30.

According to the present invention, the plurality of limited blocks and the engagement portions matched with them are provided at the periphery of the backlight module, and the light guide plate and the optical film assembly are limited by the limited blocks, so that it is helpful for reducing the space occupied by the positioning structures of the reflective sheet, the light guide plate and the optical film assembly. In comparison with providing a separate fixing mechanism in the prior art, the sizes of the limited blocks and the structures cooperating with the limited blocks on the light guide plate and the optical film assembly according to the present invention may be further decreased for being helpful designing the ultra-thin display device with the narrow bezel, thereby improving the assembling efficiency and the reliable fixation of the products.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A backlight module comprising: a light guide plate and an optical film assembly, which are stacked, and a plurality of limited blocks,
wherein, engagement portions are disposed to protrude from a periphery of the light guide plate, the number of the engagement portions is same as that of the limited blocks, and the limited blocks are fixed to a back portion of the optical film assembly, and engaged within the engagement portions.

2. The backlight module of claim 1, wherein the engagement portions are disposed on at least two opposite side walls of the light guide plate in pairs.

3. The backlight module of claim 2, wherein gaps having a shape consistent with that of the limited blocks are provided in the engagement portions, and the limited blocks are inserted into and caught in the gaps.

4. The backlight module of claim 3, wherein the limited blocks are in a rectangle shape.

5. The backlight module of claim 3, wherein the limited blocks are in a trapezoid shape.

6. The backlight module of claim 5, wherein openings of the gaps become bigger as being farther away from a center of the light guide plate.

7. The backlight module of claim 5, wherein openings of the gaps become smaller as being farther away from a center of the light guide plate.

8. The backlight module of claim 1, wherein a height of the limited blocks is higher than that of the engagement portions.

9. The backlight module of claim 1, wherein hangers are disposed to protrude from a periphery of the optical film assembly, the number of the hangers is the same as that of the limited blocks, and the limited blocks are adhesive to surfaces of the hangers.

10. The backlight module of claim 2, wherein hangers are disposed to protrude from a periphery of the optical film assembly, the number of the hangers is the same as that of the limited blocks, and the limited blocks are adhesive to surfaces of the hangers.

11. A display device comprising a display panel and a backlight module, the display panel being disposed on the backlight module,
wherein the backlight module comprises a light guide plate and an optical film assembly, which are stacked, and a plurality of limited blocks,
wherein, engagement portions are disposed to protrude from a periphery of the light guide plate, the number of the engagement portions is same as that of the limited blocks, and the limited blocks are fixed to a back portion of the optical film assembly, and engaged within the engagement portions.

12. The display device of claim 11, wherein the engagement portions are disposed on at least two opposite side walls of the light guide plate in pairs.

13. The display device of claim 12, wherein gaps having a shape consistent with that of the limited blocks are provided in the engagement portions, and the limited blocks are inserted into and caught in the gaps.

14. The display device of claim 13, wherein the limited blocks are in a rectangle shape.

15. The display device of claim 13, wherein the limited blocks are in a trapezoid shape.

16. The display device of claim 15, wherein openings of the gaps become bigger as being farther away from a center of the light guide plate.

17. The display device of claim 15, wherein openings of the gaps become smaller as being farther away from a center of the light guide plate.

18. The display device of claim 11, wherein a height of the limited blocks is higher than that of the engagement portions.

19. The display device of claim 11, wherein hangers are disposed to protrude from a periphery of the optical film assembly, the number of the hangers is the same as that of the limited blocks, and the limited blocks are adhesive to surfaces of the hangers.

20. A display device comprising a display panel and the a backlight module, the display panel being disposed on the backlight module, wherein the backlight module comprises a light guide plate and an optical film assembly, which are stacked, and a plurality of limited blocks,
wherein, engagement portions are disposed to protrude from a periphery of the light guide plate, and the number of the engagement portions is same as that of the limited blocks,
wherein the limited blocks are in a trapezoid shape and fixed to a back portion of the optical film assembly; gaps having a shape consistent with that of the limited blocks are disposed in the engagement portions, and the openings of the gaps become smaller as being are farther away from a center of the light guide plate; and the limited blocks are inserted into and caught in the gaps.
